(19) United States
(12) Patent Application Publication
(10) Pub. No.: US 2009/0059039 A1
(43) Pub. Date: Mar. 5, 2009

(54) Method and apparatus for combining multi-exposure image data

(75) Inventors: Scott Smith, Los Angeles, CA (US); Atif Sarwari, Saratoga, CA (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/896,439

(22) Filed: Aug. 31, 2007

(51) Int. Cl. H04N 5/217; H04N 5/235; H04N 5/335

(52) U.S. Cl. 348/241; 348/222.1; 348/296; 348/E05.091; 348/E05.034; 348/E05.078

(57) ABSTRACT

A method and apparatus of combining multiple exposure images by applying a transfer function to pixel output signals from pixels in a pixel array, the pixel output signals from each pixel including at least a first pixel output signal generated in response to a first exposure time and a second pixel output signal generated in response to a second exposure time.

### FIELD OF THE INVENTION

The embodiments disclosed herein relate to generally semiconductor imagers and more specifically to multi-exposure imaging.

### BACKGROUND OF THE INVENTION

The dynamic range of an imaging or camera system may be defined by the maximum and minimum illumination levels effectively captured in a single image or frame. A desired imaging device is sensitive to a broad illumination range. Unfortunately, designing an imaging device to be equally sensitive to both low and high illumination levels is limited by currently used photosensors. As a result, several techniques have been developed for extending the dynamic range of imaging devices. Some of the most common techniques include increasing the capacity of a pixel well, multi-exposure image capture, using pixel arrays containing varying pixel areas and/or pixel sensitivity, using logarithmic or other non-linear pixel response to light, and pixel-by-pixel adaptive exposure time.

Multi-exposure image capture is an attractive technique for extending the dynamic range of an imaging device. Multi-exposure image capture produces a known piecewise linear relationship between exposures and may be implemented using common imaging device architectures. In multi-exposure image capture, the same image is captured using more than one exposure time. A final image is created by summing weighted pixel values from each of the exposures. In this way, a final image output may be constructed from the linear combination of several images of varying exposure times. Unfortunately, however, the final image output is affected by a non-linear signal-to-noise ratio SNR. Due to photon shot noise limitations, as explained below, the signal-to-noise ratio SNR in multi-exposure image capture generally does not scale linearly.

Photon shot noise σₚₕ is characterized by statistical fluctuations in the rate photons are received by a pixel. Photon shot noise σₚₕ is a function of the number of photoelectrons P generated in a pixel as shown in Equation 1 below. The signal-to-noise ratio SNR of a pixel is limited by photon shot noise σₚₕ when detected signals are large (i.e., when the number of generated photoelectrons P is large). Even when photon shot noise σₚₕ is not a significant factor, however (e.g., when the detected signals are small), additional noise sources must be considered. These additional noise sources make up the read noise floor σ_{read} which refers to the residual noise of the image sensor when photon shot noise is excluded. The read noise floor σ_{read} limits the image quality in the dark regions of an image. Thus, pixel noise σ is a combination of photon shot noise σₚₕ and the read noise floor σ_{read}, as illustrated in Equation 2 below. The signal-to-noise ratio SNR is dependent upon the signal level (via both the numerator and the photon shot noise σₚₕ in the denominator) in addition to the read noise floor σ_{read} of the sensor as shown in Equation 3 below.

$$\begin{matrix}{σ}_{p h} = \sqrt{P} . & Equation 1 \\ σ = \sqrt{{σ}_{p h}^{2} + {σ}_{read}^{2}} = \sqrt{P + {σ}_{read}^{2}} . & Equation 2 \\ SNR = \frac{P}{σ} = \frac{P}{\sqrt{P + {σ}_{read}^{2}}} . & Equation 3\end{matrix}$$

Based on the signal-to-noise ratio SNR model of Equation 3, multi-exposure image capture produces a signal-to-noise ratio SNR response that contains discontinuities, meaning there are abrupt changes in the signal-to-noise ratio SNR when multiple exposures are used—the signal-to-noise ratio SNR for a dynamic range is not linear, but discontinuous. The result of the discontinuities is a visible change in the final image signal quality between regions of varying illumination (acquired through different exposure times). The discontinuities occur when the pixels saturate during a given exposure time and a transition is made to use a shorter exposure for increased light levels. FIGS. 1A, 1B and 1C demonstrate an example of the signal-to-noise ratio SNR discontinuities that occur for multiple exposure imaging. As seen in FIG. 1A, a longer exposure time (e.g., Exposure 1) is used to capture dark areas of an image (areas where the light intensity is low). The shortest exposure time (Exposure 3) is used to capture the brightest areas of the image. Other intervening exposure times may also be used (e.g., Exposure 2). The total number of exposure times used is dependent upon two values: the maximum signal-to-noise ratio SNRₘₐₓ and the minimum acceptable signal-to-noise ratio level SNRₗᵢₘ. The maximum signal-to-noise ratio SNRₘₐₓ represents the signal-to-noise ratio SNR of a saturated photosensor. Although higher signal-to-noise ratios SNRs may be desired, the maximum signal-to-noise ratio SNRₘₐₓ is limited by a maximum number of photoelectrons that a photosensor is able to collect. Using Equation 3, the maximum signal-to-noise ratio SNRₘₐₓ is determined when the photoelectrons P are at a maximum Pₘₐₓ. The minimum acceptable signal-to-noise ratio SNRₗᵢₘ is a predetermined quality-control value. On the one hand, high quality standards would require that the minimum acceptable signal-to-noise ratio SNRₗᵢₘ be as high as possible, close to the value of the maximum signal-to-noise ratio SNRₘₐₓ. If the minimum acceptable signal-to-noise ratio SNRₗᵢₘ were shifted towards the maximum signal-to-noise ratio SNRₘₐₓ, the result is a high-valued signal-to-noise ratio SNR with many small discontinuities, as illustrated in FIG. 1B. Unfortunately, in order to achieve the high signal-to-noise ratio SNR, a high number of exposure times is required. If only a few exposure times were used (e.g., Exposures 1 and 2), the dynamic range of the imaging device would be severely limited. On the other hand, if the minimum acceptable signal-to-noise ratio SNRₗᵢₘ were lowered, as illustrated in FIG. 1C, only a few exposure times would be required. However, the signal-to-noise ratio SNR will vary greatly and there will be at least one large discontinuity that will result in differences in image quality among image regions with different illumination levels. A minimum acceptable signal-to-noise ration SNRₗᵢₘ that reduces both the number of exposure times required and the size of the discontinuities between exposure times is preferred.

One well known method for combining multiple exposure image data is to use simple image addition and an exposure ratio factor to compensate for exposure differences. FIG. 2 shows a block diagram of a circuit 10 used to add two exposures. In FIG. 2, the photoelectrons accumulated in a pixel P(i, j) in row m of an imager are measured in response to two different exposure times, Exposure 1 and Exposure 2. A signal representing the number of collected photoelectrons in pixel P(i, j) in response to Exposure 1 is output as signal P₁(i, j). A signal representing the number of collected photoelectrons in pixel P(i, j) in response to Exposure 2 is output as signal P₂(i, j). The two output signals P₁(i, j), P₂(i, j) are summed after applying an exposure weighting factor α to signal P₂(i, j). The resulting output signal is Pₒᵤₜ(i, j), which is equal to P₁(i, j)+αP₂(i, j). The resulting signal-to-noise ratio SNR from combining different exposures using addition is shown below in Equation 4. The exposure ratio factor α doesn't change the signal-to-noise ratio SNR since both the signal and noise are multiplied by the same factor. Thus, the exposure factor is not included in Equation 4.

$$SNR = \frac{{P}_{1} + {P}_{2}}{\sqrt{{P}_{1} + {P}_{2} + 2 {σ}_{read}^{2}}} . \qquad Equation 4$$

Equation 4 may be plotted against Equation 3 in order to demonstrate the negative aspects of using simple image addition in multi-exposure imaging. FIGS. 3A-3C illustrate the use of Equation 3 to plot the signal-to-noise ratio for both a long exposure P₁ and a short exposure P₂. Equation 4 is also used to plot a summed exposure P₁+P₂. The comparison shows that in low-illumination levels, the signal-to-noise ratio is decreased when the two signals P₁, P₂ are summed. The comparison also shows that summing signals P₁, P₂ results in an increase in the discontinuity that occurs at the transition from signal P₁ to signal P₂. The plots in FIGS. 3A-3C were made using an exposure ratio α of 10, a photosensor full well of 10,000 e⁻ and a readout noise floor σ^{read} of 10 e⁻.

As another example, consider the low-light case when P₁=100 e⁻, P₂=10 e⁻, σ_{read}=10 e⁻ and σ=10. When just using the long exposure signal P₁, for low light situations, the signal-to-noise ratio SNR is 7.07, as shown below in Equation 5. However, when both exposures are added, the signal-to-noise ratio SNR is reduced to 6.25, as shown below in Equation 6.

$$\begin{matrix}SNR = \frac{{P}_{1}}{\sqrt{{P}_{1} + {σ}_{read}^{2}}} = 7.07 . & Equation 5 \\ SNR = \frac{{P}_{1} + {P}_{2}}{\sqrt{{P}_{1} + {P}_{2} + 2 {σ}_{read}^{2}}} = 6.25 . & Equation 6\end{matrix}$$

The above example shows that for low light levels where photo shot noise doesn't dominate the signal-to-noise ratio SNR, the overall signal-to-noise ratio SNR is reduced when adding the two exposures.

There is a need and desire, therefore, to achieve a desired dynamic range increase while avoiding signal-to-noise ratio SNR discontinuity artifacts in the resulting images.

### BRIEF DESCRIPTION OF THE DRAWINGS

FIGS. 1A-1C are graphs that illustrate the signal-to-noise ratio SNR discontinuities that occur during multiple exposure imaging.

FIG. 2 is a summing circuit for combining multiple exposure image data.

FIGS. 3A-3C are graphs that illustrate the signal-to-noise ratio SNR resulting from use of the summing circuit of FIG. 2.

FIG. 4 is a weighted transfer function circuit for combining multiple exposure image data according to a disclosed embodiment.

FIG. 5 is graph that illustrates the signal-to-noise ratio SNR resulting from the use of the weighted transfer function circuit of FIG. 4, according to a disclosed embodiment.

FIG. 6 is a graph of a weighted transfer function according to a disclosed embodiment.

FIG. 7 is a block diagram of a CMOS semiconductor imager according to a disclosed embodiment.

FIG. 8 is a block diagram of a processing system that includes an imaging device according to a disclosed embodiment.

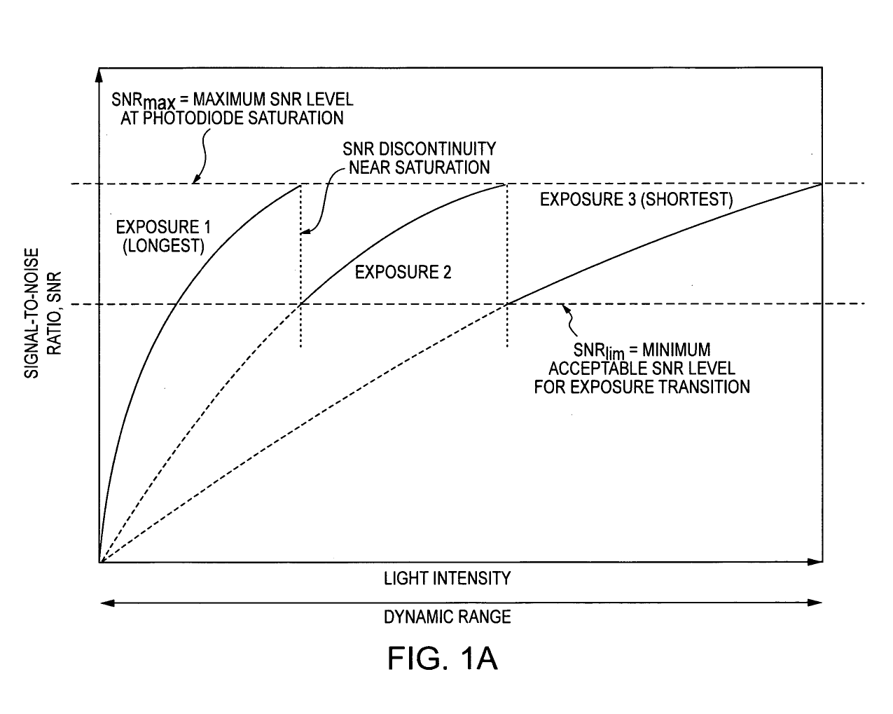

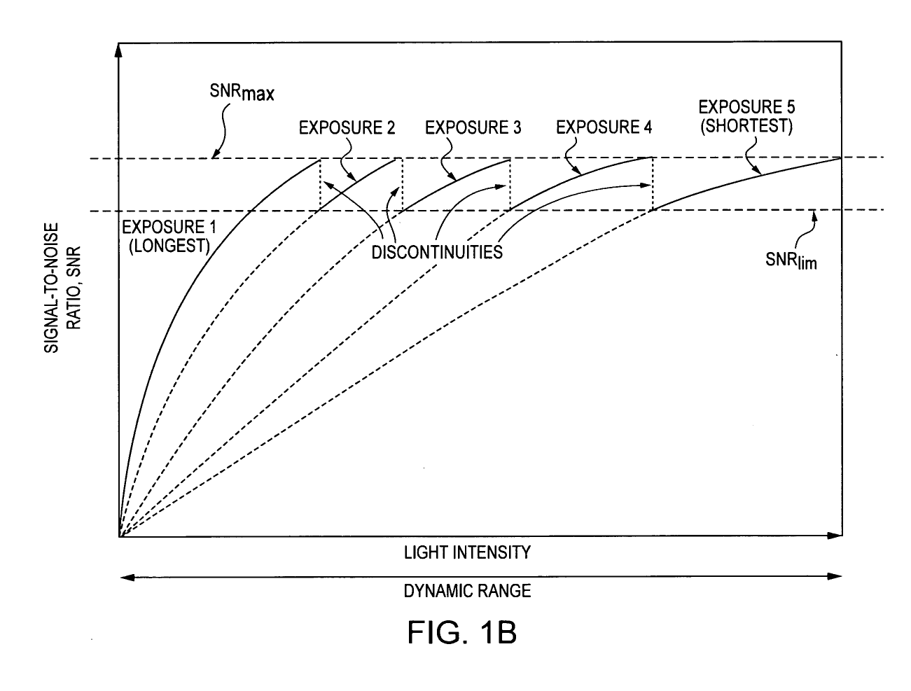

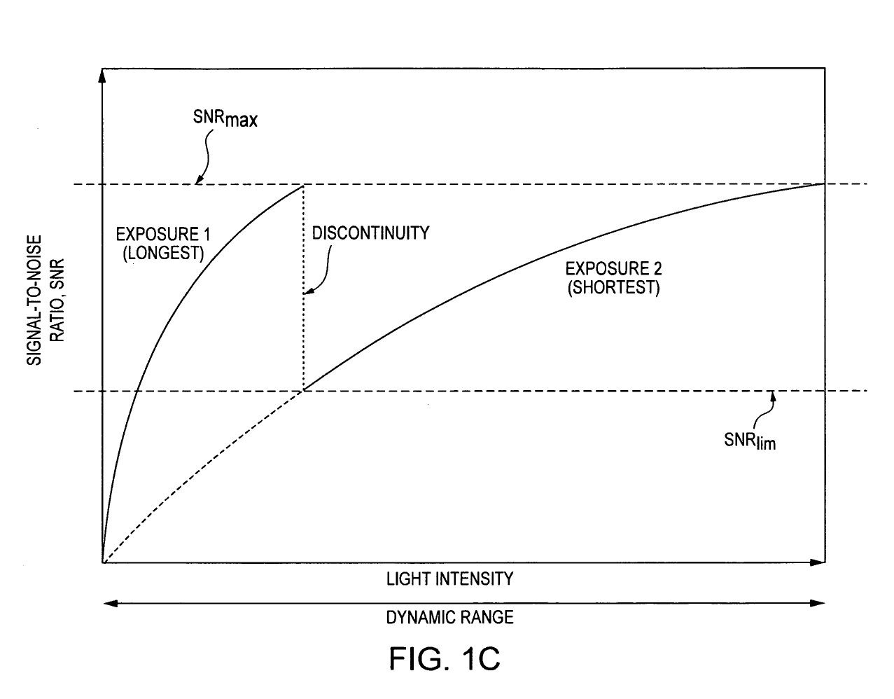

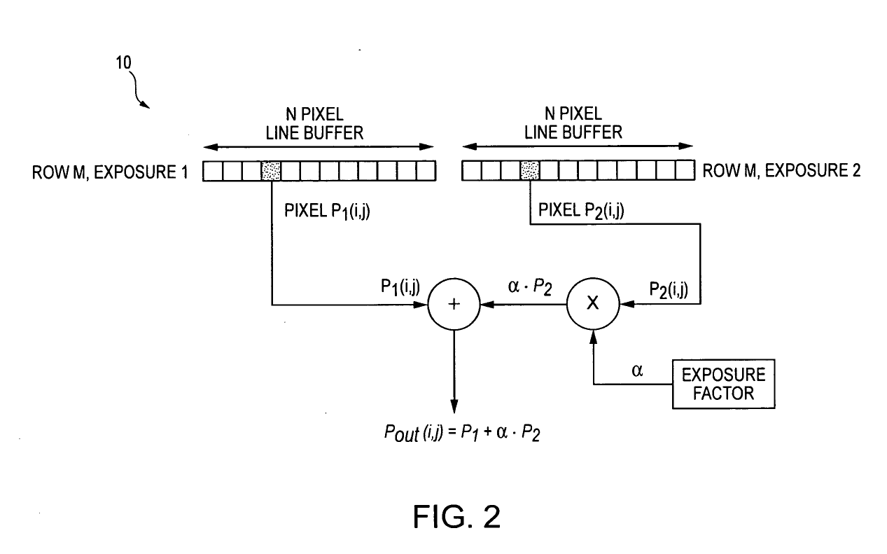

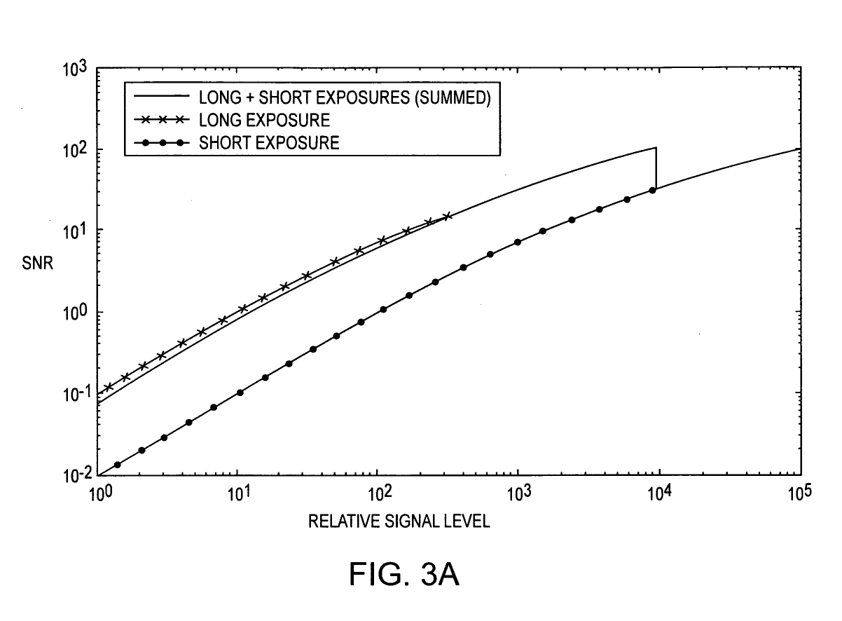

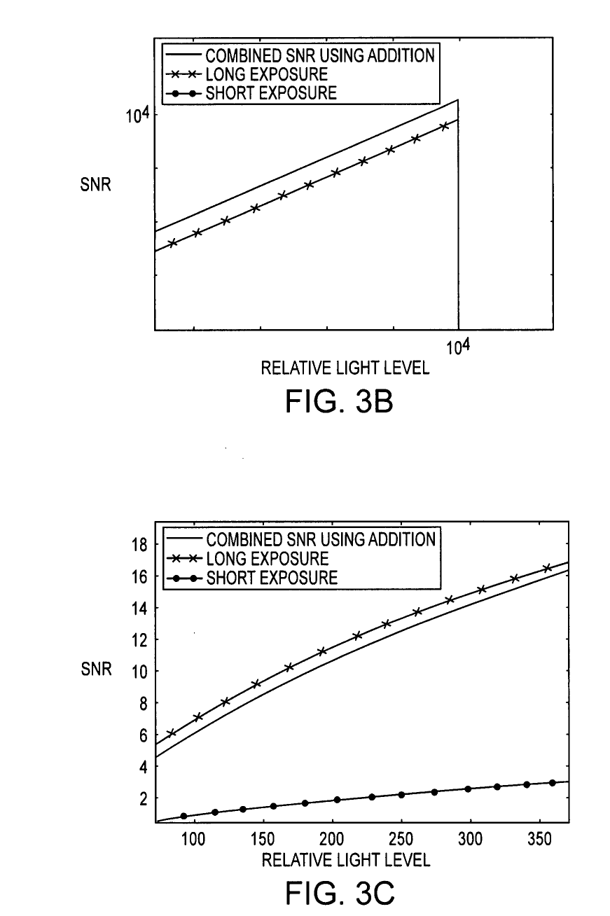

### DETAILED DESCRIPTION OF THE INVENTION

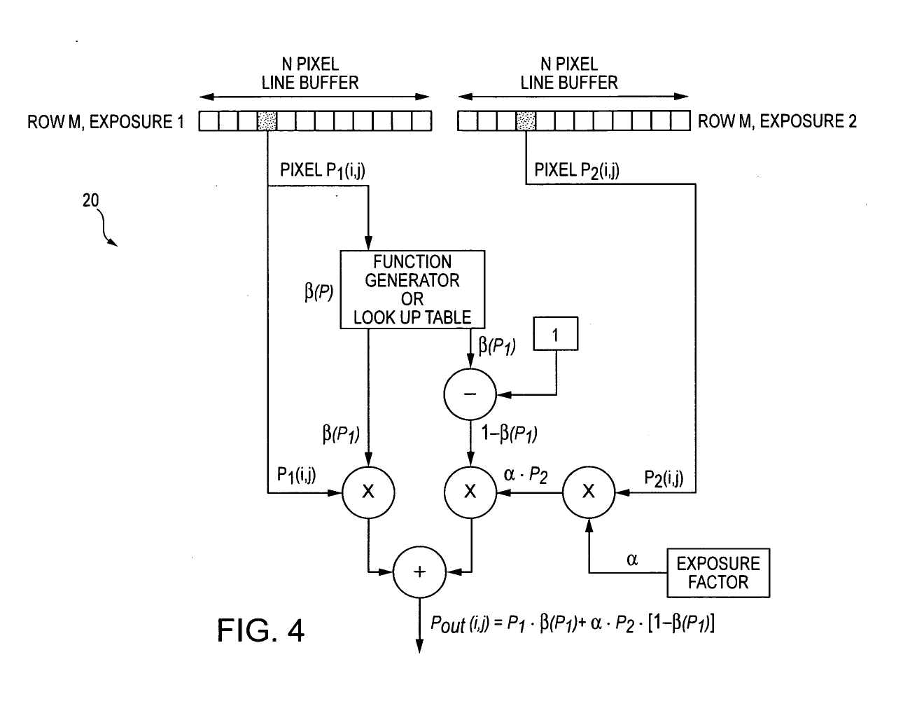

In order to achieve improved signal-to-noise ratio SNR performance across the entire dynamic range available via multi-exposure imaging, a transfer function is applied to both long and short exposure signals so that only the long exposure signal is used for low light intensity (low signal levels), only the short exposure signal is used for high signal levels, and both signals are mixed close to the exposure transition points (the points at which a discontinuity exists between the signal-to-noise ratios SNRs of two different exposures). The block diagram of FIG. 4 shows the circuit 20 used to combine exposures using the transfer functions.

In FIG. 4, a transfer function β(P) is applied to signals from pixel P(i, j). A signal representing the number of collected photoelectrons in pixel P(i, j) in response to Exposure 1 is output as signal P₁ (for convenience, the indices (i, j) are omitted). Similarly, a signal representing the number of collected photoelectrons in pixel P(i, j) in response to Exposure 2 is output as signal P₂. The pixel output P₂ is weighted by exposure factor α. If desired, pixel output P₁ may also be weighted by a different exposure factor. The transfer function β(P) is applied to signal P₁ to yield transfer signal β(P₁). In one branch of FIG. 4, the transfer signal β(P₁) is multiplied with the pixel output signal P₁ to create signal P₁·β(P₁). In another branch, the transfer signal β(P₁) is subtracted from 1 to create an inverse function 1−β(P₁). Inverse function 1−β(P₁) is applied to the weighted pixel output α·P₂ to yield a signal α·P₂[1−β(P₁)]. The resulting signal α·P₂[1−β(P₁)] is summed with signal P₁·β(P₁) to create output signal Pₒᵤₜ(i, j), which is equal to P₁·β(P₁)+α·P₂[1−(P₁)].

The transfer function β(P) may be generated on the fly using a function generator and a known explicit equation or may be a look-up table LUT of values. The output range of the transfer function is zero to one. Thus, the function 1−β(P) is an inverse transfer function of function β(P). The transfer and inverse transfer functions act as weighting functions providing varying weights to either signal P₁ or P₂, depending on the signal level. One skilled in the art will recognize that the transfer function β(P) may alternatively be applied to signal P₁, with the inverse transfer function being applied to P₂, as long as the transfer function β(P) is modified appropriately.

The technique and circuit 20 described in relation to FIG. 4 allows multiple exposures to be combined so that the signal-to-noise ratio SNR is improved with reduced discontinuities across the dynamic range of the system. For example, the transfer function β(P) may be designed to output a 1 for the long exposure signal P₁ and a 0 for the short exposure signal P₂ when the long exposure signal P₁ is small in order to avoid adding noise from the short exposure signal P₂. Other transfer functions β(P) may of course be used as long as the function results in the improvement of the signal-to-noise ratio SNR and reduced discontinuities over the entire dynamic range of the image sensors.

$$SNR = \frac{{P}_{1} \cdot β ( {P}_{1} ) + {P}_{2} \cdot [ 1 - β ( {P}_{1} ) ]}{\sqrt{( {P}_{1} + {σ}_{R}^{2} ) \cdot {β}^{2} ( {P}_{1} ) + ( {P}_{2} + {σ}_{R}^{2} ) \cdot {[ 1 - β ( {P}_{1} ) ]}^{2}}} . \qquad Equation 7$$

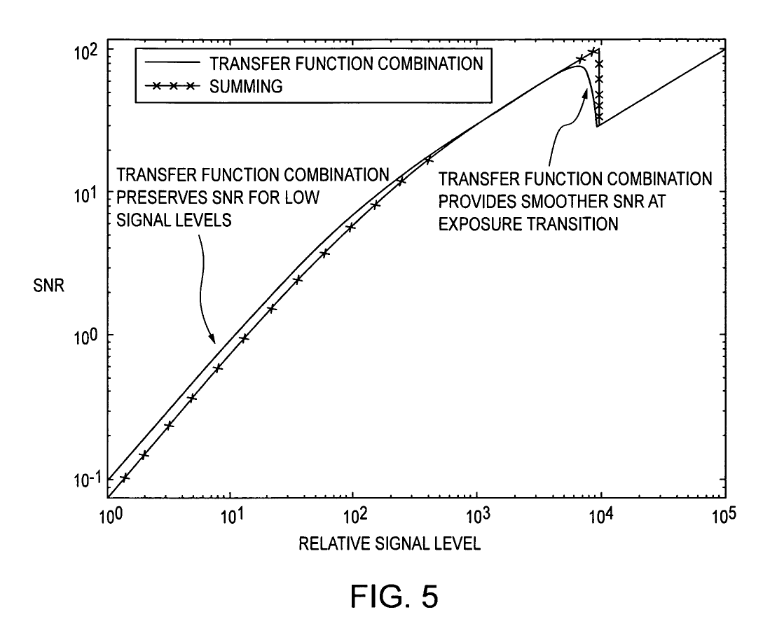

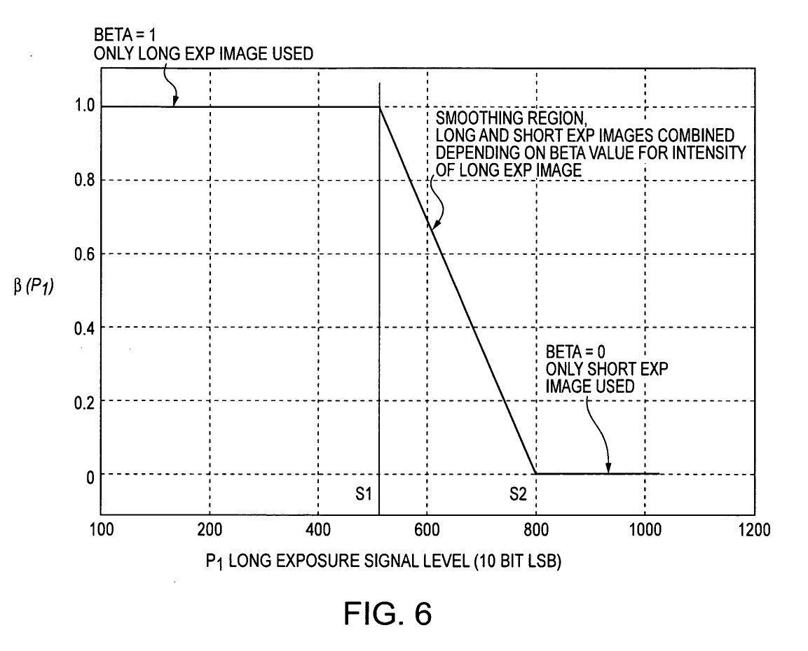

Equation 7 above shows the signal-to-noise ratio SNR after combining signals P₁, P₂ using a weighted transfer function. Equation 7 may be used to plot signal-to-noise ratio SNR results in order to demonstrate the effect of transfer function β(P). FIG. 5 illustrates the signal-to-noise ratio SNR using a weighted transfer function as defined below in Equation 8 and illustrated in FIG. 6. In FIG. 5, the signal-to-noise ratio SNR resulting from the weighted transfer function is compared with the signal-to-noise ratio SNR resulting from basic summing of exposure signals. It is apparent that the signal-to-noise ratio SNR resulting from a weighted transfer function is generally improved across the entire dynamic range of the system while the discontinuity at the exposure signal transition point is less.

The signal-to-noise ratio SNR resulting from the transfer function plotted in FIG. 5 is derived from the transfer function in Equation 8 below and illustrated in FIG. 6. The transfer function of Equation 8 is an example of a linear transfer function for a defined transition region S₁ to S₂ with a value of 1 for input values less than S₁ and 0 for input values greater than S₂. The transition region S₁ to S₂ is a range of signal levels that includes the signal level at which a transition point or discontinuity exists between signal-to-noise ratios SNRs of different exposure times. The transition region boundaries S₁, S₂ may be equidistant from the transition point, or may be shifted so that the transition point is closer to one of the boundaries S₁, S₂. The boundaries S₁, S₂ or methods of determining the boundaries S₁, S₂ are selected in advance.

$$β ( {P}_{1} ) = \{ \begin{matrix}1 & {P}_{1} < {S}_{1} \\ \frac{{S}_{2} - {P}_{1}}{{S}_{2} - {S}_{1}} & {S}_{1} \leq {P}_{1} \leq {S}_{2} \\ 0 & {S}_{2} < {P}_{1} .\end{matrix} \qquad Equation 8$$

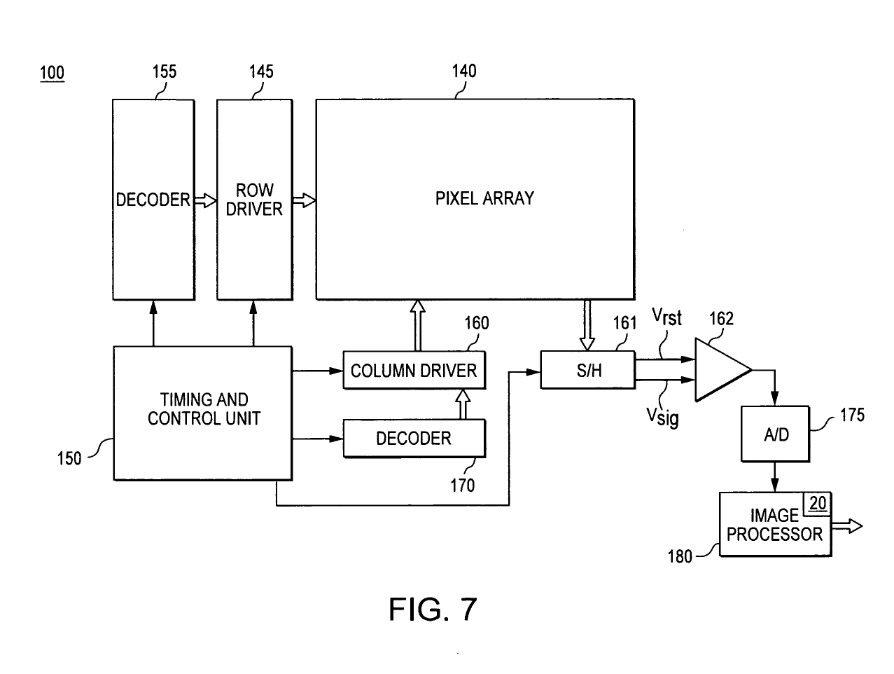

The circuit 20 illustrated in FIG. 4, including the transfer function β(P) may be implemented using either hardware or software or via a combination of hardware and software. For example, in a semiconductor CMOS imager 100, as illustrated in FIG. 7, the circuit 20 may be implemented within the image processor 180. FIG. 7 illustrates a simplified block diagram of a semiconductor CMOS imager 100 having a pixel array 140 including a plurality of pixel cells arranged in a predetermined number of columns and rows. Each pixel cell is configured to receive incident photons and to convert the incident photons into electrical signals. Pixel cells of pixel array 140 are output row-by-row as activated by a row driver 145 in response to a row address decoder 155. Column driver 160 and column address decoder 170 are also used to selectively activate individual pixel columns. A timing and control circuit 150 controls address decoders 155, 170 for selecting the appropriate row and column lines for pixel readout. The control circuit 150 also controls the row and column driver circuitry 145, 160 such that driving voltages may be applied. Each pixel cell generally outputs both a pixel reset signal vᵣₛₜ and a pixel image signal v_{sig}, which are read by a sample and hold circuit 161 according to a correlated double sampling (“CDS”) scheme. The pixel reset signal vᵣₛₜ represents a reset state of a pixel cell. The pixel image signal v_{sig} represents the amount of charge generated by the photosensor in the pixel cell in response to applied light during an integration period. The pixel reset and image signals vᵣₛₜ, v_{sig} are sampled, held and amplified by the sample and hold circuit 161. The sample and hold circuit 161 outputs amplified pixel reset and image signals Vᵣₛₜ, V_{sig}. The difference between V_{sig} and Vᵣₛₜ represents the actual pixel cell output with common-mode noise eliminated. The differential signal (e.g., Vᵣₛₜ−V_{sig}) is produced by differential amplifier 162 for each readout pixel cell. The differential signals are digitized by an analog-to-digital converter 175. The analog-to-digital converter 175 supplies the digitized pixel signals to an image processor 180, which forms and outputs a digital image from the pixel values. The output digital image is a result of the combination of multiple exposures in the circuit 20 of the or at least controlled by the image processor 180.

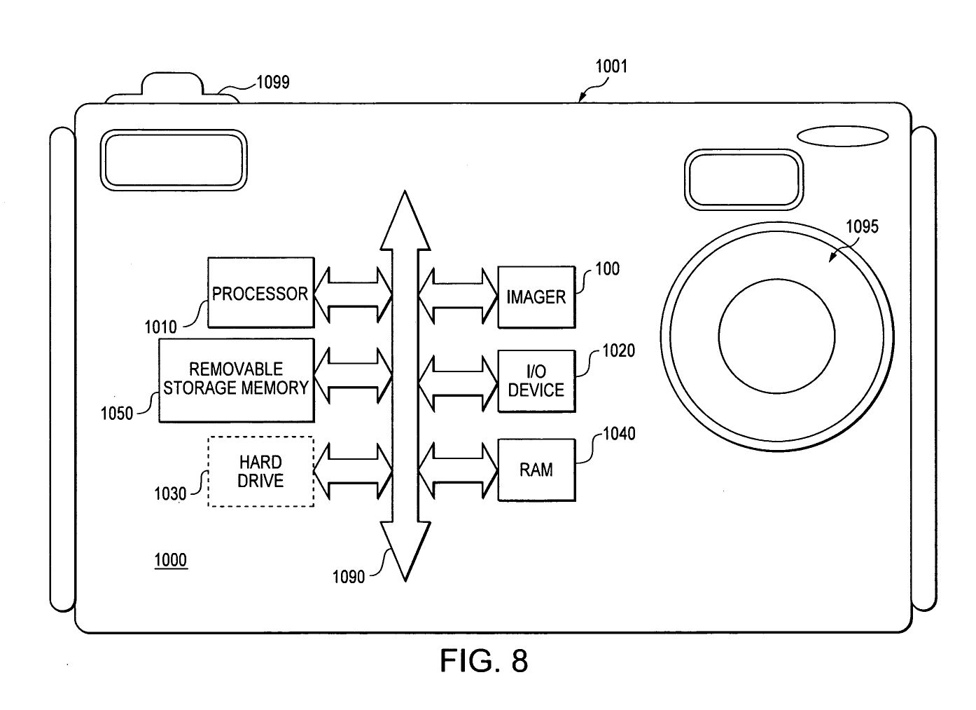

The circuit 20 and transfer function β(P) of FIG. 4 may be used in any system which employs an imager device, including, but not limited to a computer system, camera system, scanner, machine vision, vehicle navigation, video phone, surveillance system, auto focus system, star tracker system, motion detection system, image stabilization system, and other imaging systems. Example digital camera systems in which the invention may be used include both still and video digital cameras, cell-phone cameras, handheld personal digital assistant (PDA) cameras, and other types of cameras. FIG. 8 shows a typical processor system 1000 which is part of a digital camera 1001. The processor system 1000 includes an imaging device 100 which includes either software or hardware to implement multi-exposure imaging in accordance with the embodiments described above. System 1000 generally comprises a processing unit 1010, such as a microprocessor, that controls system functions and which communicates with an input/output (I/O) device 1020 over a bus 1090. Imaging device 100 also communicates with the processing unit 1010 over the bus 1090. The processor system 1000 also includes random access memory (RAM) 1040, and can include removable storage memory 1050, such as flash memory, which also communicates with the processing unit 1010 over the bus 1090. Lens 1095 focuses an image on a pixel array of the imaging device 100 when shutter release button 1099 is pressed.

The processor system 1000 could alternatively be part of a larger processing system, such as a computer. Through the bus 1090, the processor system 1000 illustratively communicates with other computer components, including but not limited to, a hard drive 1030 and one or more removable storage memory 1050. The imaging device 100 may be combined with a processor, such as a central processing unit, digital signal processor, or microprocessor, with or without memory storage on a single integrated circuit or on a different chip than the processor.

It should again be noted that although the embodiments of the invention have been described with specific reference to CMOS imaging devices, the embodiments have broader applicability and may be used in any imaging apparatus which generates pixel output values, including charge-coupled devices CCDs and other imaging devices.

1. A multi-exposure imaging circuit, comprising:
at least one pixel signal input for carrying a first and a second pixel output signal from a same pixel, the first pixel output signal generated in response to a first exposure time and the second pixel output signal generated in response to a second exposure time;
a transfer function circuit for applying a transfer function to the first pixel output signal resulting in a transfer signal and an inverse transfer function to the second pixel output signal resulting in an inverse transfer signal; and
summing circuitry for summing the transfer and inverse transfer signals into a combined output signal.

2. The circuit of claim 1, wherein the transfer function has a first value for pixel output signal levels less than a first predetermined signal level, a second value for pixel output signal levels greater than a second predetermined signal level, and a plurality of values in between the first value and the second value for pixel output signal levels between the first and second predetermined signal levels.

3. The circuit of claim 2, wherein the plurality of values in between the first value and the second value are defined by a linear equation.

4. The circuit of claim 1, wherein the transfer function circuit generates the transfer function using either a function generator or a look-up table.

5. (canceled)

6. The circuit of claim 1, further comprising weighting circuitry for applying an exposure factor to at least one of the first and second pixel output signals before the transfer function or inverse transfer function is applied.

7. The circuit of claim 6, the exposure factor is applied to the second pixel output signal resulting in a weighted second pixel output signal, the inverse transfer signal arising from the application of the inverse transfer function to the weighted second pixel output signal.

8. The circuit of claim 1, wherein the first exposure time is longer than the second exposure time.

9. The circuit of claim 8, wherein the combined output signal has a signal-to-noise ratio that is approximately equal to a signal-to-noise ratio of the first pixel output signal for pixel output signal levels less than a first predetermined signal level and the second pixel output signal for pixel output signal levels greater than a second predetermined signal level.

10. (canceled)

11. The circuit of claim 8, wherein the combined output signal has a signal-to-noise ratio that is less than a signal-to-noise ratio of a summed first and second pixel output signals in between a first and second predetermined signal level.

12. An imager, comprising:
a pixel array; and
a multiple exposure image circuit that applies a transfer function and an inverse transfer function to pixel output signals from pixels in the pixel array, the pixel output signals from each pixel including at least a first pixel output signal generated in response to a first exposure time and a second pixel output signal generated in response to a second exposure time.

13. (canceled)

14. The imager of claim 12, wherein the multiple exposure circuit applies the transfer function to the first pixel output signal from each pixel resulting in a transfer signal and the inverse transfer function to the second pixel output signal from each pixel resulting in an inverse transfer signal.

15. The imager of claim 14, wherein the multiple exposure circuit combines the transfer signal and the inverse transfer signal.

16-18. (canceled)

19. The imager of claim 12, wherein the transfer function has a first value for pixel output signal levels less than a first predetermined signal level, a second value for pixel output signal levels greater than a second predetermined signal level, and a plurality of values in between the first value and the second value for pixel output signal levels between the first and second predetermined signal levels.

20. The imager of claim 19, wherein the plurality of values in between the first value and the second value are defined by a linear equation.

21. (canceled)

22. The imager of claim 12 wherein the transfer function is generated by one of a function generator and a look-up table.

23. The imager of claim 12, wherein the multiple exposure image combination circuit applies an exposure factor to the second pixel output signal.

24. A processing system, comprising:
a processor; and
an imaging device coupled to said processor, said imaging device comprising:
a pixel array that outputs a first pixel output signal and a second pixel output signal for each pixel in the pixel array, the first pixel output signal arising from a first exposure time and the second pixel output signal arising from a second exposure time; and
a multiple exposure image circuit for applying a transfer function to the first pixel output signal and an inverse transfer function to the second pixel output signal.

25-31. (canceled)

32. The system of claim 24, wherein the multiple exposure image circuit applies an exposure factor to the second pixel output signal.

33. The system of claim 24, wherein the processing system is a camera system.

34. A method of combining multiple exposures of an image, the method comprising:
receiving a first pixel signal from one or more pixels exposed to a first exposure time;
receiving a second pixel signal from the one or more pixels exposed to a second exposure time;
applying a transfer function to the first pixel signal;
applying an inverse transfer function to the second pixel signal; and
combining the transferred first pixel signal and the transferred second pixel signal.

35. The method of claim 34, wherein the first exposure time is longer than the second exposure time.

36. The method of claim 35, wherein the transfer function has a first value for pixel output signal levels less than a first predetermined signal level, a second value for pixel output signal levels greater than a second predetermined signal level, and a plurality of values in between the first value and the second value for pixel output signal levels between the first and second predetermined signal levels.

37. The method of claim 34, wherein the combined signals have a signal-to-noise ratio that is approximately equal to a signal-to-noise ratio of the first pixel signal for pixel signals less than a predetermined signal level and the second pixel output signal for pixel output signal levels greater than a second predetermined signal level.

38. (canceled)

39. The method of claim 34, wherein the combined signals have a signal-to-noise ratio that is less than a signal-to-noise ratio of a summed first and second pixel signals in between a first and second predetermined signal level.

40. The method of claim 34, further comprising applying a weighted exposure factor to the second pixel signal before the inverse transfer function is applied.

41. (canceled)
